(19) United States
(12) Patent Application Publication
(10) Pub. No.: US 2005/0264668 A1
(43) Pub. Date: Dec. 1, 2005

(54) Electronic apparatus with image capturing function and image display method

(75) Inventor: Shuji Miyamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/138,678

(22) Filed: May 27, 2005

(30) Foreign Application Priority Data
May 28, 2004 (JP) P2004-159950

(51) Int. Cl. H04N 5/222

(52) U.S. Cl. 348/333.11

(57) ABSTRACT

An electronic apparatus with an image capturing function, includes an image capturing unit for capturing an image of a subject, a display for displaying the image of the subject to be captured by the image capturing unit, a memory for storing image data of the image captured by the image capturing unit, a processor for integrating the image data stored in the memory with the image of the subject to be captured by the image capturing unit, and a display controller for causing the display to display an image integrated by the processor.

### CROSS-REFERENCE TO RELATED APPLICATIONS

This application claims the benefit of priority of Japanese Patent Application No. 2004-159950, filed May 28, 2004, the entire contents of which are incorporated herein by reference.

### BACKGROUND

1. Field

The present invention relates to an electronic apparatus with an image capturing function and an image display method and, in particular, to an electronic apparatus with an image capturing function and image display method for capturing an image of a subject by referencing image information concerning an image captured in the past.

2. Description of the Related Art

Technology of electronic apparatuses with an image capturing function, such as digital cameras, has dramatically advanced. Digital cameras are currently in widespread use.

In the digital camera, captured image data is stored in a memory as digital data, and the stored image data is relatively easily manipulated in a digital process. The digital camera thus performs functions that cannot be accomplished by conventional analog camera.

Jpn Pat. Publication No. 2003-189160 discloses a technique that synthesizes past image data and currently captured image data in a digital camera. With this technique, a person A in the past image data and a person B in currently captured image data are synthesized into a picture that looks as if the persons A and B were photographed together side by side.

Jpn Pat. Publication No. 2001-8081 synthesizes two pieces of past image data by reproducing and partially overlapping one past image data on the other, and produces third image data. This technique provides an image equivalent to an image having a view stretching in wide space by synthesizing a plurality of pieces of image data that have been captured with field of view successively shifted.

In accordance with the above disclosed techniques, at least two pieces of image data as a result of photographing different subjects are synthesized to produce new image data different from each of actually captured original data.

By reproducing the past original image data on the digital camera, a photographer easily determines a camera angle of a new image that is synthesized from the past original image data.

The above disclosed techniques satisfy photographers' needs for images taken in different locations but at almost the same time, namely, for images synthesized from images of different subjects.

On the contrary, there are also photographers' needs for images taken in different times at almost the same locations.

For example, parents may wish to record the growth of their children or even plants in the same background and under the same photographing conditions (such as camera angle, zooming, aperture diaphragm, range to a subject) at regular intervals.

There is also a need for recording products, which may be model-changed each year, in the same background and under the same photographing conditions as much as possible.

There is also a strong need for recording a plurality of subjects, which cannot be theoretically photographed at the same time slot, in the same background and under the same photographing conditions even at different time slots.

To satisfy such needs, a photographer must rebuild a past scene under past photographing conditions using a tripod, for example.

The photographer may have to repeatedly compare a current image with a past image by reproducing the past image to cause the photographing conditions of the currently captured image of a subject and the photographing conditions of the past image to match each other.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are external views of a digital camera with an image capturing function in accordance with one embodiment of the present invention;

FIG. 2 is a block diagram of the digital camera with the image capturing function in accordance with the one embodiment of the present invention;

FIG. 3 is a functional diagram of an integrating processor of the electronic apparatus in accordance with the one embodiment of the present invention;

FIG. 4 is a system diagram of a integrating processor in accordance with a first embodiment of the present invention;

FIGS. 5A-5D illustrate a concept of the integrator and the process in accordance with the first embodiment of the present invention;

FIG. 6 is a system diagram an integrating processor in accordance with a second embodiment of the present invention;

FIGS. 7A-7D illustrate a concept of the integrator and process in accordance with the second embodiment of the present invention;

FIG. 8 is a system diagram of an integrating processor in accordance with a third embodiment of the present invention;

FIGS. 9A-9D illustrate a concept of the integrating processor in accordance with the third embodiment of the present invention;

FIG. 10 is a system diagram of an integrating processor in accordance with a fourth embodiment of the present invention; and

FIGS. 11A-11D illustrate a concept of the integrating processor in accordance with the fourth embodiment of the present invention.

### DETAILED DESCRIPTION

An electronic apparatus and an image display method as embodiments of the present invention are described below with reference to the drawings.

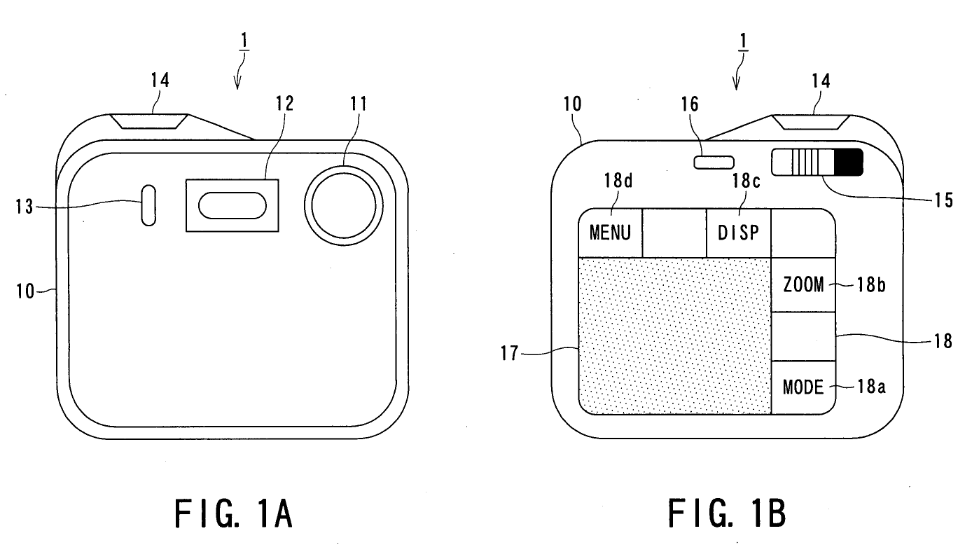

FIGS. 1A and 1B are external views of a digital camera 1 in accordance with one embodiment of the present invention. FIG. 1A is a front view of the digital camera 1 and FIG. 1B is a rear view of the digital camera 1.

As shown in FIG. 1A, the digital camera 1 includes a case 10 housing elements of the digital camera 1. Arranged on the front of the case 10 are a lens unit 11, a flash lamp 12 to be used during camera flashing, and a self-timer lamp 13 for indicating that a self-timer photographing operation is currently in progress.

A shutter button 14 is arranged on the top of the case 10. A power switch 15 for switching on and off the digital camera 1 and an indicator 16 for indicating whether power to the digital camera 1 is on or off are arranged on the top portion of the back of the case 10.

An LCD (liquid-crystal display) 17 is arranged on the center of the back of the case 10. The LCD 17 displays not only new image data of a subject to be captured but also preceding image data captured in the past and stored in a memory card 33. The LCD 17 also displays information relating to photographing conditions.

The information relating to the photographing conditions refers to information of a camera angle of the digital camera 1, for example. The camera angle information of the digital camera 1 contains tilt angle information or attitude information, range information between the digital camera 1 and a subject, exposure information such as an aperture diaphragm and shutter speed, and zooming information such as zoom magnification.

The LCD 17 further displays a variety of menus and icons (each icon is a line drawing or silhouette representing a target to be processed or a content of a process).

A touchpanel 18 is arranged on the back of the digital camera 1 for a user to perform a variety of operations. The touchpanel 18 includes a plurality of function keys. The function keys include a mode key 18a for switching between modes, a zooming key 18b for controlling a zoom operation, a display key 18c for switching the display content of the LCD 17, and a menu key 18d for displaying a variety of menus.

A removable cover (not shown) is arranged on the bottom of the digital camera 1 and is opened when each of the memory card 33 and a battery 100 is replaced.

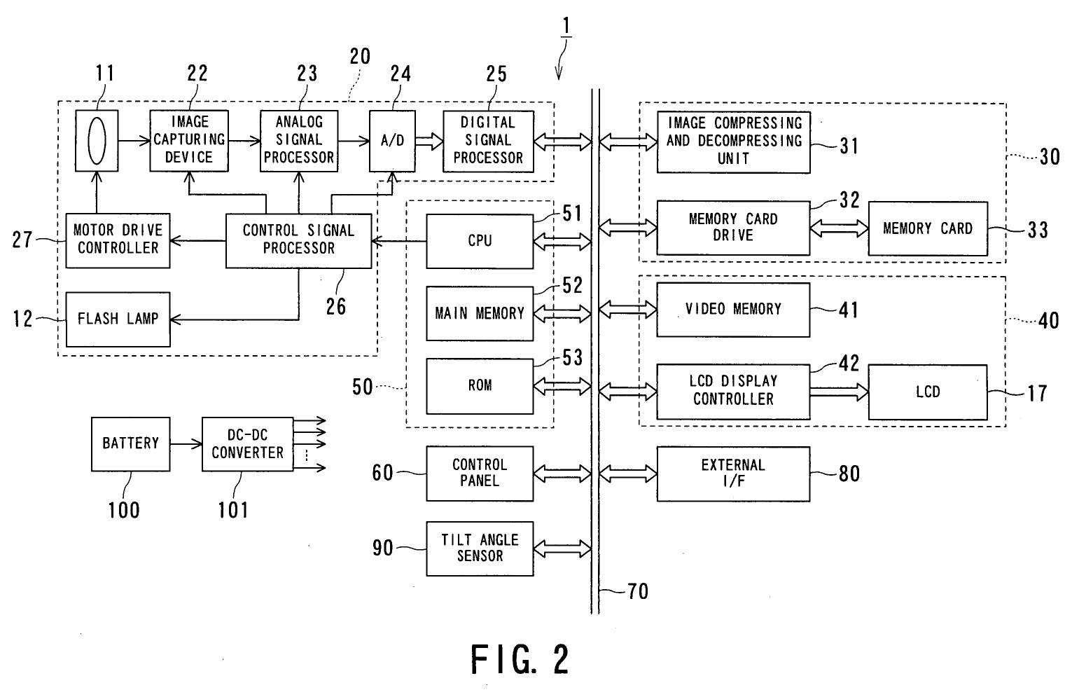

FIG. 2 illustrates the system structure of the digital camera 1.

The digital camera 1 includes, in the case 10 thereof, an image capturing section 20 for picking up light reflected from a subject and converting the image of the subject into image data, a storage 30 for storing the acquired image data onto a nonvolatile memory, a display 40 for displaying, on the LCD 17, the image data of the subject to be captured, and image data captured in the past, and an integrating processor 50 for controlling the entire digital camera 1 and integrating the image data.

The image capturing section 20, the storage 30, the display 40, and the integrating processor 50 are interconnected to each other via a bus 70.

The digital camera 1 includes a control panel 60. The control panel 60 includes the shutter button 14, the power switch 15, the touchpanel 18, etc., and is used by a user in operation as necessary.

The digital camera 1 further includes an external I/F (interface) 80 for establishing communications with external apparatuses such as a personal computer. The external I/F 80 is used to connect the digital camera 1 to the external personal computer via a universal serial bus (USB) cable. Through the external I/F 80, the digital camera 1 downloads the image data stored in the storage 30 to the personal computer.

The digital camera 1 further includes the battery 100 for supplying DC power to elements thereof, a DC-DC converter 101, and a tilt angle sensor 90 for detecting a tilt angle of the digital camera 1.

The image capturing section 20 includes the lens unit 11, an image capturing device 22, composed of charge-coupled device (CCD) elements, an analog signal processor 23, an analog-to-digital (A/D) converter 24, and a digital signal processor 25, all connected in cascade fashion in that order.

The image capturing section 20 further includes a control signal generator 26 for generating a variety of control signals, a motor driver controller 27 for driving the lens unit 11 with a motor in zoom and focus adjustments, and a flash lamp 12.

The storage 30 includes a memory card 33, which is a removable nonvolatile memory, a memory card drive 32 for controlling reading and writing of image data on the memory card 33, and an image compressing and decompressing unit 31 for compressing and decompressing image data.

The display 40 includes, in addition to the LCD 17, arranged on the back of the digital camera 1, for displaying the image data, a video memory 41 for storing temporarily the image data, and an LCD display controller 42 for controlling displaying of the image data on the LCD 17.

The integrating processor 50 includes a CPU 51 for generally controlling the digital camera 1 and integrating the image data. The integrating processor 50 further includes a ROM 53 for storing software programs to be executed by the CPU 51, and a main memory 52 functioning as a work area of the CPU 51 and temporarily storing the image data.

A basic photograph mode and a reproduction mode of the digital camera 1 are described below with reference a system diagram of FIG. 2.

During the basic photograph mode, the light reflected from a subject is collected by the lens unit 11 and the image of the subject is then focused on the image capturing device 22.

With the motor driving a lens of the lens unit 11 in position, the focus and zoom adjustments are performed. The motor is driven by a drive signal the motor driver controller 27 generates in response to a control signal from the control signal generator 26.

The image capturing device 22 is composed of a two-dimensional array of CCDs (charge-coupled devices).

The output of the image capturing device 22 is an analog signal. The analog signal processor 23 performs analog-signal processes including an automatic gain control process on the analog signal. The resulting analog signal is then converted into a digital signal by the A/D converter 24.

The digital signal processor 25 performs a variety of correction processes on the input digital signal, and outputs the corrected signal to the bus 70 as image data.

Under the control of the CPU 51, the control signal generator 26 generates clock signals and various control signals, which are then to be supplied to the image capturing device 22, the analog signal processor 23, and the A/D converter 24.

The control signal generator 26 controls flashing of the flash lamp 12 in a flashing operation during night, for example.

The image data output from the digital signal processor 25 to the bus 70 is temporarily stored in the video memory 41 in the display 40. The image data stored in the video memory 41 is successively read into the LCD display controller 42 via the bus 70, and is then displayed on the LCD 17 arranged on the back of the digital camera 1.

The user can capture the image of the subject at a desired angle by changing a tilt angle or an attitude angle of the digital camera 1 while viewing the image data on the LCD 17. The user can also set the image of the subject at a desired magnification by operating the zooming key 18b in the touchpanel 18.

Upon determining that the image of the subject is set at the desired angle and zooming state, the user presses the shutter button 14 to by half stroke.

In response to the half-stroke pressing of the shutter button 14, the digital camera 1 sets the lens position, the aperture diaphragm, and the shutter speed to appropriate values in auto-focus function and an auto exposure function thereof.

Upon setting the focus and exposure to the appropriate states thereof, the digital camera 1 notifies the user by means of a sound or an indication on the LCD 17 that the digital camera 1 is now ready to photograph.

The user recognizes the photograph-ready state, and photographs the subject by pressing further the shutter button 14.

The image data stored in the video memory 41 is successively updated until the user presses the shutter button 14. At the moment the shutter button 14 is pressed, in other words, the shutter is released, the updating of the image data is suspended thereafter. The image data at the moment of the shutter release is stored in the video memory 41.

The image data stored in the video memory 41 is stored in the memory card 33 in the storage 30 via the bus 70 in response to an operation of the user or automatically.

When the image data stored in the video memory 41 is stored in the memory card 33, the image compressing and decompressing unit 31 in the storage 30 compresses the image data and then the compressed image data is stored in the memory card 33.

The image data may be compressed in accordance with JPEG (Joint Photographic Experts Group) standards, for example.

The image data compressed by the image compressing and decompressing unit 31 is input to the memory card drive 32 via the bus 70, and is then stored onto the memory card 33 under the control of the memory card drive 32.

The memory card 33 is a nonvolatile memory such as a flash memory. The memory card 33 stores, in addition to the image data, image management information such as an image number in the basic photograph mode.

The basic photograph mode of the digital camera 1 has been discussed above.

Meanwhile, the digital camera 1 is controlled by the CPU 51 in the integrating processor 50 throughout the basic photograph mode.

Next, the reproduction mode of the digital camera 1 is described below.

The user can switch from the basic photograph mode to the reproduction mode by operating the mode key 18a of the touchpanel 18.

During the reproduction mode, past image data stored in the memory card 33 is read and then displayed on the LCD 17.

More specifically, the image data stored in the memory card 33 is read under the control of the memory card drive 32, and is then input to the image compressing and decompressing unit 31 via the bus 70. The image compressing and decompressing unit 31 decompresses the JPEG compressed image data.

The image data output to the video memory 41 is displayed on the LCD 17 via the LCD display controller 42.

Although a plurality of image data can be stored in the memory card 33, the user can select any one from among the plurality of image data on a menu screen of the LCD 17 and display the selected image data on the LCD 17.

The user can display the plurality of image data at the same time on small windows, namely, thumbnail images of the image data.

The plurality of image data stored in the memory card 33 may be selectively displayed on the LCD 17 one after another.

The selection and control of the display method are performed by the CPU 51 in the integrating processor 50.

The external I/F 80 establishes connections with a variety of external devices. For example, the digital camera 1 can be connected to the personal computer via the USB cable so that the image data stored in the memory card 33 is downloaded to the personal computer.

A television receiver can be connected to the external I/F 80 via an audio video (AV) cable. The user can display the image data stored in the memory card 33 not only on the LCD 17 but also on a large-size screen of the television receiver.

Next a same-angle-photograph mode is described below.

The same-angle-photograph mode refers to a mode in which image data captured in the past (preceding image data) and image data to be captured (new image data) can be photographed at the same camera angle.

Generally, the camera angle refers to an attitude angle of the digital camera 1 relative to the subject. However, during the same-angle-photograph mode, the preceding image data and the new image data match each other not only in angle but also in the exposure condition such as the aperture diaphragm and the shutter speed, and the photographing conditions such as zooming as much as possible.

The user can switch from one of the basic photograph mode and the reproduction mode to the same-angle-photograph mode by operating the mode key 18a.

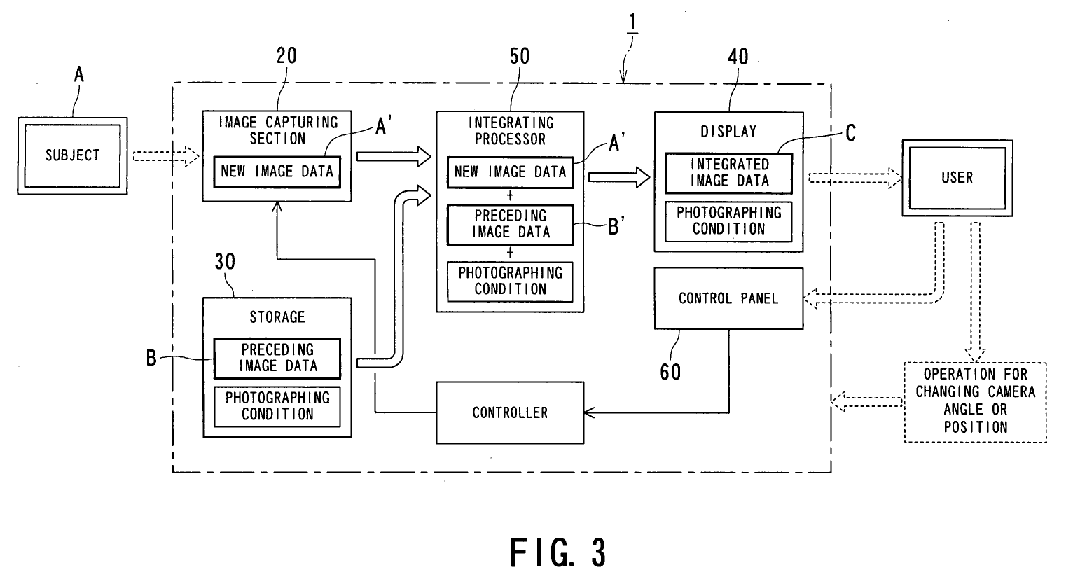

The same angle mode is described below with reference to FIG. 3.

The image capturing section 20 converts light reflected from a subject A into image data A′ (new image data). The operation of the image capturing section 20 is identical to that in the basic photograph mode. More specifically, the light reflected from the subject A is focused on the image capturing device 22, and is then successively processed, converted and then processed by the analog signal processor 23, the A/D converter 24, and the digital signal processor 25, respectively. The image data A′ is then output to the bus 70.

The image data A′ output to the bus 70 is input to the integrating processor 50. The integrating processor 50 temporarily stores the image data A′ in a predetermined area (area A′) of the main memory 52.

The image data A′ is the data of the image of the subject A, and is changing from moment to moment in response to the range of the digital camera 1 to the subject and the angle of the digital camera 1 (the attitude angle of the digital camera 1 held by the user). The image data A′ stored in the main memory 52 is updated at predetermined intervals, for example, every 1/30 second.

During the same angle mode, the image data (preceding image data) B stored in the memory card 33 in the storage 30 is also input to the integrating processor 50 via the bus 70.

More specifically, the preceding image data B stored in the memory card 33 is JPEG-compressed data, and is thus input to the image compressing and decompressing unit 31 for decompression. The decompressed preceding image data B is temporarily stored in a predetermined area (area B) of the main memory 52 via the bus 70.

The preceding image data B can be selected from a plurality of image data stored in the memory card 33. For example, the image stored in the memory card 33 can be displayed in thumbnail images to allow the user to select any desired preceding image data B from among the plurality of image data.

The integrating processor 50 integrates the new image data A′ and the preceding image data B.

The integration process is intended to integrate the new image data A′ of the subject to be captured and the preceding image data B so that the two pieces of data are displayed to the user in an easy-to-see manner at the same time or at almost the same time.

The image data C integrated by the integrating processor 50 is temporarily stored in a predetermined area (area C) of the main memory 52. The integrated image data C is then transferred to the video memory 41 in the display 40, and is then displayed on the LCD 17 via the LCD display controller 42.

The user views the integrated image data C displayed on the LCD 17, thereby easily recognizing the degree of difference in angle between the preceding image data B and the new image data A′.

The user can make the preceding image data B and the new image data A′ match each other in angle by modifying the attitude angle of the digital camera 1.

If the subjects appear substantially different in size between the preceding image data B and the new image data A′, the range of the digital camera 1 to the subject may be adjusted to result in the subjects having the same size in video. If the digital camera 1 has a zoom function, the user can perform a zoom operation on the control panel 60 to adjust the size of the subject in video.

Upon determining from the viewing of the LCD 17 that the preceding image data B and the new image data A′ match each other in angle, the user releases the shutter by pressing the shutter button 14.

Once the shutter is released, the updating of the new image data A′ is suspended. The new image data A′ is output from the area A′ in the main memory 52 to the storage 30 via the bus 70.

In the same manner as during the basic photograph mode, the image compressing and decompressing unit 31 in the storage 30 compresses the new image data A′, and the compressed new image data A′ is stored in the memory card 33 via the memory card drive 32.

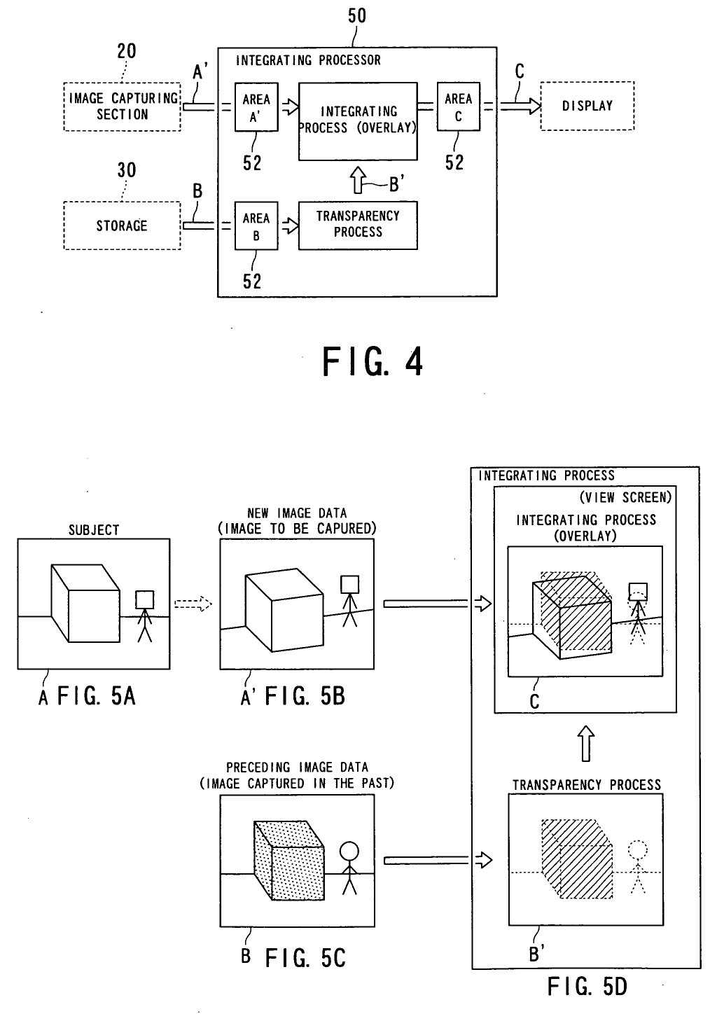

FIG. 4 is a system diagram of the integrating processor 50 in accordance with a first embodiment of the present invention. FIGS. 5A-5D diagrammatically illustrate the image data that is processed in an integration process in accordance with the first embodiment of the present invention.

FIG. 5A diagrammatically illustrates the subject A to be photographed.

FIG. 5B displays the new image data A′ of the subject A captured by the image capturing section 20 in the digital camera 1. Depending on the attitude angle of the digital camera 1, the new image data A′ captured by the image capturing section 20 fails to match the subject A.

FIG. 5C illustrates the preceding image data B that was captured in the past by photographing a subject similar to the subject A. The preceding image data B is selected by the user from among the image data stored in the memory card 33 in the integrating processor 50.

During the same-angle-photograph mode, the new image data A′ of FIG. 5B is temporarily stored in the area A′ in the main memory 52 of the integrating processor 50.

The preceding image data B of FIG. 5c is temporarily stored in the area B in the main memory 52.

In accordance with the first embodiment, a transparency process is performed on the preceding image data B. In the transparency process, a front image is manipulated so that a rear image can be seen through the front image when the front image and the rear image are overlaid on each other.

The transparency process may be performed using a variety of techniques. In one-technique, pixels of the image data are decimated at a predetermined decimation ratio.

For example, the preceding image data B is decimated at a decimation ratio of one to one, pixels adjacent to each other are alternately decimated in a checkered pattern. The area of a decimated pixel becomes blank.

FIG. 5D illustrates, as preceding image data B′, the image data that is obtained by performing the decimation transparency process on the preceding image data B.

The transparency process is performed by the CPU 51 in the integrating processor 50. The preceding transparency-processed image data B′ overwrites the area B in the main memory 52.

The preceding transparency processed image data B′ is overlaid on the new image data A′. As a result, the preceding image data B′ and the new image data A′ are concurrently viewed. FIG. 5D illustrates the integrated image data C.

The overlay process is performed by the CPU 51, and the integrated image data C is stored in an area C in the main memory 52.

The integrated image data C is transferred to the video memory 41 in the display 40, and is then displayed on the LCD 17 via the LCD display controller 42.

In accordance with the integration process of the first embodiment, the new image data A′ to be captured and the preceding image data B captured in the past are concurrently viewed on the LCD 17 if the same-angle-photograph mode is set in the digital camera 1.

As a result, the user easily recognizes a difference between the new image data A′ and the preceding image data B by monitoring the integrated image data C displayed on the LCD 17. The user sets the same angle as the preceding image data B by adjusting the angle while watching the LCD 17.

In the conventional digital camera without the same-angle-photograph mode, the user needs to display the preceding image data B on the LCD 17 during the reproduction mode when the user photographs the subject A at the same angle as the preceding image data B. The user then memorizes the preceding image data B, and switches to the basic photograph mode, and adjusts the angle of the new image data A′.

In the convention digital camera, the angle of the preceding image data B cannot be accurately equalized with the angle of the new image data A′. To accurately equalize the camera angles, the user needs to check the angles on the LCD 17 by repeatedly switching back and forth between the reproduction mode and the basic photographing mode.

In accordance with the first embodiment, during the same-angle-photograph mode, the user can easily equalize the new image data A′ and the preceding image data B in angle.

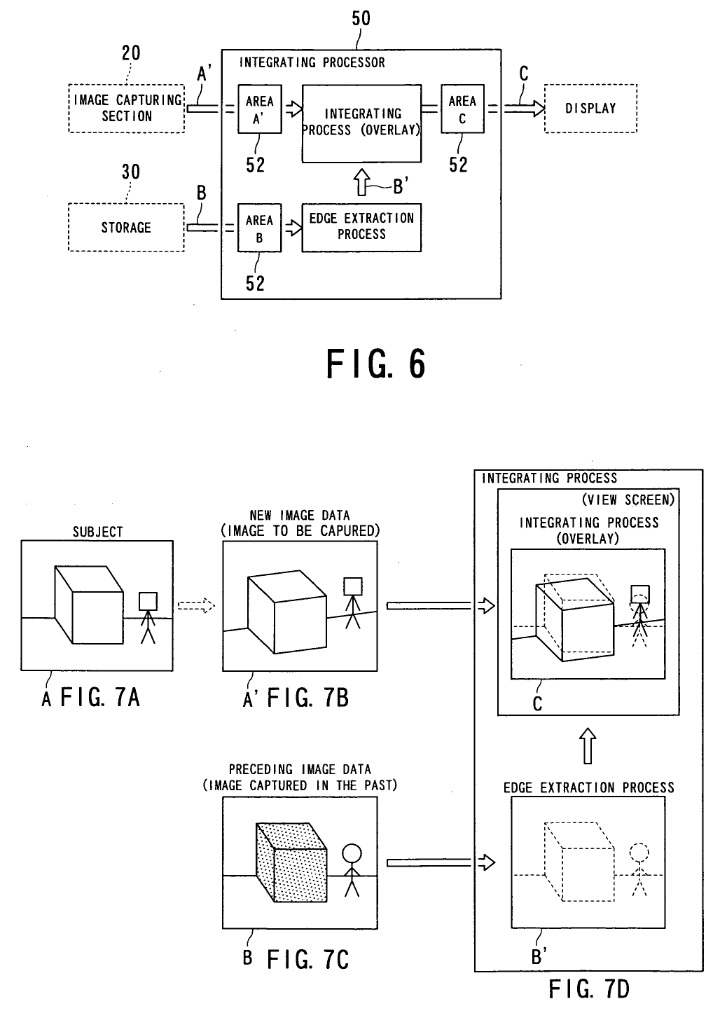

FIG. 6 illustrates a system diagram of an integrating processor 50 in accordance with a second embodiment of the present invention. FIGS. 7A-7D diagrammatically illustrate image data that is integrated in accordance with an integration process of the second embodiment.

In accordance with the integration process of the second embodiment, the preceding image data B of FIG. 7C is subjected to an edge extraction process rather than the transparency process of the first embodiment. The preceding edge-extraction-processed image data B is then overlaid on the new image data A′.

As a result of the edge extraction process, only an edge portion of the preceding image data B is extracted, and the remaining portion of the data B becomes blank. FIG. 7D illustrates preceding edge-extraction-processed image data B′.

A variety of edge extraction techniques are available. The present invention is not limited to any particular edge extraction technique.

For example, if an original image is a color image, the original image is converted into a gray scale image. The gray scale image is then binarized with respect to a predetermined luminance threshold into white and black. An edge in the original image can be extracted by detecting discontinuity points of white or black in the binarized image.

In another technique, an original image is Fourier transformed, and a high-frequency component is then extracted using a high-pass filter. The high-frequency component is then inverse Fourier transformed to detect an edge of the original image. Luminance and color continuously and smoothly change in an area other than the edge, and the frequency component on that area is low and thus removed by the high-pass filter. As a result, an edge having the high-frequency component resides.

The edge extraction process is executed by the CPU 51 in the integrating processor 50. The preceding edge-extraction-processed image data B′ overwrites the area B in the main memory 52 as in the first embodiment, and is overlaid on the new image data A′.

The overlay process is also performed by the CPU 51. The resulting integrated image data C is temporarily stored in the area C in the main memory 52.

The integrated image data C is transferred to the video memory 41 in the display 40, and is then displayed on the LCD 17 via the LCD display controller 42.

In accordance with the second embodiment, the preceding image data B and the new image data A′ are concurrently displayed on the LCD 17. The second embodiment thus provides the same advantages as the first embodiment.

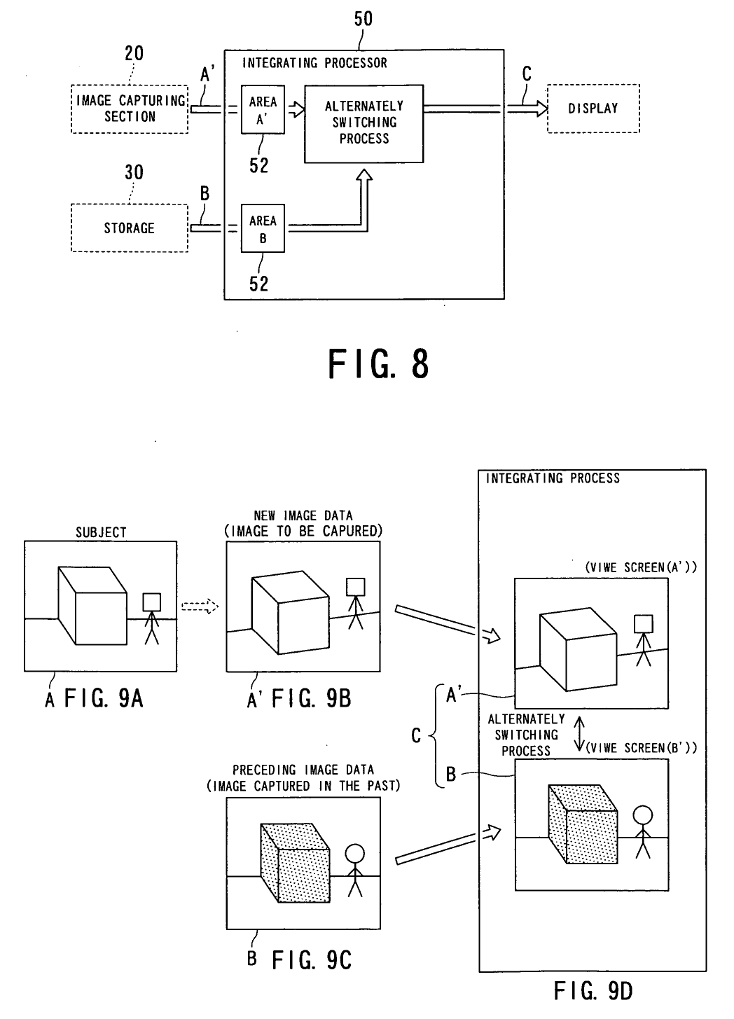

FIG. 8 illustrates a system diagram of an integrating processor 50 in accordance with a third embodiment of the present invention. FIGS. 9A-9D diagrammatically illustrates image data that is processed in an integration process in accordance with the third embodiment.

In accordance with the third embodiment, the new image data A′ is temporarily stored in an area A′ in the main memory 52 in the integrating processor 50 as in the first embodiment. The preceding image data B is also temporarily stored in an area B in the main memory 52.

In the integration process of the third embodiment, the new image data A′ and the preceding image data B are alternately written on the video memory 41 in the display 40 in a time-division manner.

The image data written on the video memory 41 is displayed on the LCD 17 via the LCD display controller 42. In accordance with the third embodiment, the new image data A′ and the preceding image data B are alternately displayed on the LCD 17 in a time-division manner.

The period of time-division is not limited to any particular value. For example, the new image data A′ may be displayed for one second, followed by the preceding image data B displayed for 0.5 second. This cycle may be repeated.

An arrangement may be incorporated so that the user can modify the display period of the new image data A′ and the display period of the preceding image data B by operating the control panel 60.

The third embodiment is slightly underperformed by the first and second embodiment in terms of concurrent visibility. However, since the LCD 17 automatically alternates between the new image data A′ and the preceding image data B, the third embodiment achieves almost the same advantage.

The third embodiment is free from the transparency process and the edge extraction process, therefore the workload imposed on the digital camera 1 is lighter than in the first and second embodiments. The system of the third embodiment is thus simplified.

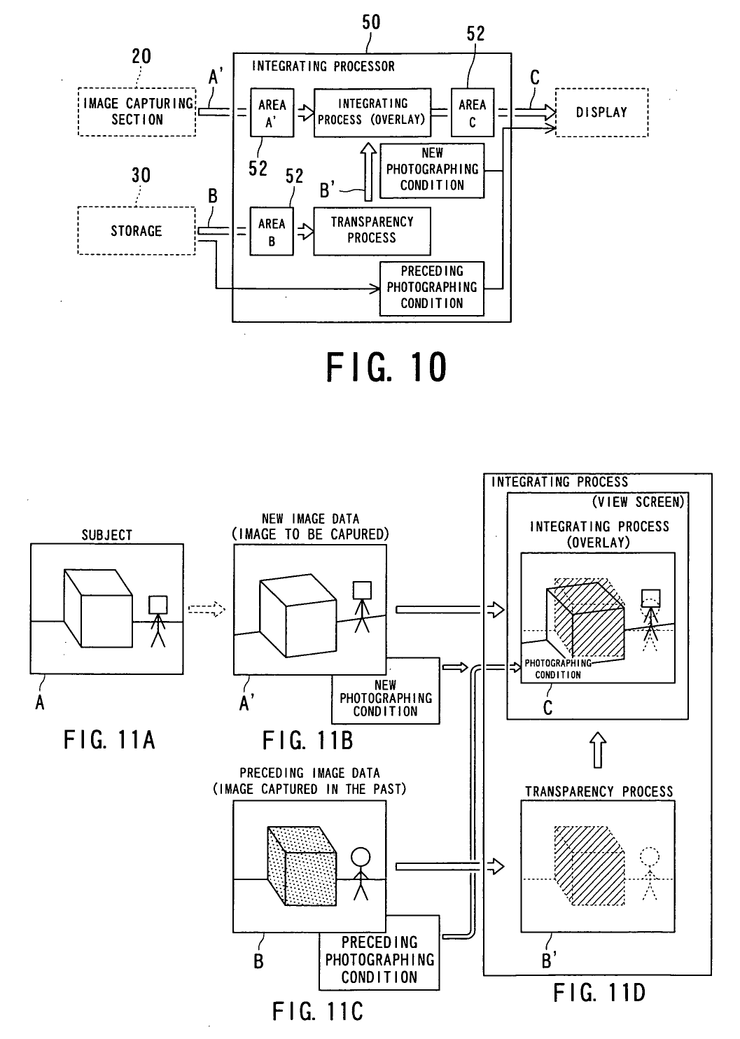

FIG. 10 is a system diagram of an integrating processor 50 in accordance with a fourth embodiment of the present invention. FIGS. 11A-11D are an illustration of image data that is processed in an integration process in accordance with the fourth embodiment of the present invention.

In accordance with the fourth embodiment of the present invention, photographing conditions such as an angle are displayed together with the integrated image data C on the LCD 17.

The information relating to the photographing conditions includes tilt angle information of the digital camera 1, information concerning a range to a subject, information relating to exposure conditions such as aperture diaphragm and shutter speed.

The tilt angle information is acquired from the tilt angle sensor 90 in the digital camera 1 as previously discussed with reference to the system configuration of FIG. 2. The CPU 51 can receive, via the bus 70, the tilt angle information that is acquired from the tilt angle sensor 90 at the moment the preceding image data B is captured.

The tilt angle sensor 90 is not limited to any particular type. For example, a two-axis sensor for detecting gravity acceleration can detect a pitch angle and a roll angle of the digital camera 1. If a direction sensor for detecting the earth's magnetic field is attached, a three-axis attitude angle can be detected.

If the digital camera 1 is of the type that performs an auto-focus function based on range information from a range sensor, the CPU 51 can acquire the range information from the range sensor.

The CPU 51 controls exposure and thus recognizes exposure conditions such as the aperture diaphragm and the shutter speed.

If the digital camera 1 has a zoom function, the CPU 51 controls the zoom function, and thus recognizes zooming information.

The photographing conditions of the digital camera 1, such as angle information, the tilt information (or attitude angle information), the range information, the exposure information, and the zooming information, can be acquired by the CPU 51.

In accordance with the fourth embodiment, the memory card 33 stores, together the preceding image data B, information concerning the photographing conditions during each of the basic photograph mode and the same-angle-photograph mode under the control of the CPU 51.

If the user selects the same-angle-photograph mode, the integrated image data C is displayed together with the information concerning the photographing conditions such as the angle on the LCD 17 via the LCD display controller 42.

The information relating to the photographing conditions displayed on the LCD 17 is laid out so that the information at the photographing of the preceding image data B (preceding photographing conditions) is easily compared with information relating to the current photographing conditions (new photographing conditions).

To prevent information from being crammed, the user may select desired information for displaying.

In accordance with the fourth embodiment, the user can easily compare not only the image data, but also the current photographing conditions with past photographing conditions. As a result, the angle of the preceding image data B is accurately equalized with the angle of the new image data A′.

The present invention is not limited to the above-referenced embodiments. Changes and modifications to the embodiments are possible without departing from the scope of the present invention. A plurality of elements in the above-referenced embodiments are combined in a variety of forms, and such combinations also fall within the scope of the present invention.

In accordance with the fourth embodiment of FIGS. 10 and 11A-11D, the integrated image data C obtained in the first embodiment and the photographing conditions are displayed. Alternatively, the integrated image data C obtained in one of the second and third embodiments may be displayed together with the photographing conditions.

In accordance with the above-referenced embodiments, the temporary storage area of the image data for use in the integration process is a predetermined area in the main memory 52 in the integrating processor 50. Alternatively, the image data may be stored in a predetermined area in the video memory 41 in the display 40.

In accordance with the above-referenced embodiments, the CPU 51 in the integrating processor 50 generally controls the digital camera 1 while performing the integration process such as image synthesis. Alternatively, the integration process such as image synthesis may be performed by a dedicated processor.

1. An electronic apparatus with an image capturing function, comprising:
an image capturing unit for capturing an image of a subject;
a display for displaying the image of the subject to be captured by the image capturing unit;
a memory for storing an image data of the image captured by the image capturing unit;
a processor for integrating the image data stored in the memory with the image of the subject to be captured by the image capturing unit; and
a display controller for causing the display to display an image integrated by the processor.

2. The electronic apparatus according to claim 1, wherein the processor performs a transparency process on the image data stored in the memory, and overlays, for integration, the image data obtained through the transparency process, on the image of the subject to be captured by the image capturing unit.

3. The electronic apparatus according to claim 1, wherein the processor performs an edge extraction process on the image data stored in the memory, and overlays, for integration, the image data obtained through the edge extraction process, on the image of the subject to be captured by the image capturing unit.

4. The electronic apparatus according to claim 1, wherein the processor switches in a time-division manner between the image data stored in the memory and the image of the subject to be captured by the image capturing unit.

5. The electronic apparatus according to claim 1, further comprising a unit for causing the display to display information relating to image photographing conditions under which the image capturing unit captures the image of the subject,
wherein the memory stores the information relating to the image photographing conditions.

6. The electronic apparatus according to claim 1, further comprising a tilt angle sensor for detecting a tilt angle; and
a unit for causing the display to display information, relating to image photographing conditions, including information concerning the tilt angle detected by the tilt angle sensor,
wherein the memory stores the information, relating to the image photographing conditions, including the information concerning the tilt angle detected by the tilt angle sensor.

7. An image display method of an electronic apparatus with an image capturing function, including an image capturing unit for capturing an image of a subject, and a display for displaying the image of the subject to be captured by the image capturing unit, the image display method comprising:
storing an image data, captured by the image capturing unit, onto a memory;
integrating the image data stored in the memory with the image of the subject to be captured by the image capturing unit; and
causing the display to display the integrated image.

8. The image display method according to claim 7, wherein the integrating step comprises performing a transparency process on the image data stored in the memory, and overlaying, for integration, the image data obtained through the transparency process, on the image of the subject to be captured by the image capturing unit.

9. The image display method according to claim 7, wherein the integrating step comprises performing an edge extraction process on the image data stored in the memory, and overlaying, for integration, the image data obtained through the edge extraction process, on the image of the subject to be captured by the image capturing unit.

10. The image display method according to claim 7, wherein the integrating step comprises switching in a time-division manner between the image data stored in the memory and the image of the subject to be captured by the image capturing unit.

11. The image display method according to claim 7, further comprising causing the display to display information relating to image photographing conditions under which the image capturing unit captures the image of the subject,
wherein the storing step comprises storing the information relating to the image photographing conditions.

12. The image display-method according to claim 7, further comprising causing the display to display information, relating to image photographing conditions, including information concerning a tilt angle detected by a tilt angle sensor,
wherein the storing step comprises storing the information, relating to the image photographing conditions, including the information concerning the tilt angle.
